(19) United States
(12) Patent Application Publication
(10) Pub. No.: US 2010/0188342 A1
(43) Pub. Date: Jul. 29, 2010

(54) Method and System for Positioning a Graphical User Interface

(75) Inventor: William Dunn, Alpharetta, GA (US)

Correspondence Address: STANDLEY LAW GROUP LLP, 6300 Riverside Drive, Dublin, OH, 43017, US

(73) Assignee: MANUFACTURING RESOURCES INTERNATIONAL, INC., Alpharetta, GA (US)

(21) Appl. No.: 12/359,429

(22) Filed: Jan. 26, 2009

(51) Int. Cl. G06F 3/01; G06F 3/048; G06F 3/041

(52) U.S. Cl. 345/173; 715/702; 715/781; 715/810

(57) ABSTRACT

Exemplary embodiments provide a method and system for shifting a graphical user interface around a touch screen display so that the menus and icons can be utilized from a plurality of user access positions. A first locating touch from the user may be used to determine the user's access position and the graphical user interface may be located on the display based on this locating touch. Embodiments allow touch screen menus and icons to be automatically positioned around a user without having to move the entire display or forcing the user to reposition themselves. Exemplary embodiments provide large portrait-oriented displays for use in restaurants, and especially in drive through applications and may also contain an electrical connection to a second display located within the restaurant.

### CROSS-REFERENCE TO RELATED APPLICATIONS

This application is a non-provisional patent application and does not claim priority to any other applications.

### TECHNICAL FIELD

Exemplary embodiments relate generally to a touch screen display capable of re-orienting its graphical user interface in order to accommodate a plurality of access positions.

### BACKGROUND AND SUMMARY OF EXEMPLARY EMBODIMENTS

Electronic displays have become popular for not only indoor entertainment purposes, but are now being utilized for indoor and outdoor advertising/informational purposes. For example, liquid crystal displays (LCDs), plasma displays, and many other flat panel displays are now being used to display information and advertising materials to consumers in locations outside of their own home. An extension of this movement has been an increased use in touch screen technology, so that consumers may interact with these displays in a variety of ways. Exemplary flat panel touch screen displays can now be used in outdoor environments.

One industry which has become increasingly interested in touch screen technology is the service industry, particularly food service. The taking of food orders by a restaurant employee is a time consuming task and the common methods present several issues for restaurant owners. Language barriers, inattentive restaurant personnel, and in the case of drive through restaurants, poor sound microphones and speakers can create inefficiency and mistakes in a customer's order. Thus, the industry has looked to touch screens as an alternative to the past methods. A touch screen is provided to the customer, and through a series of menus and icons, an order can be placed in an efficient manner with less opportunity for mistake. The screens are also capable of displaying the menus in a plurality of different languages, so that language barriers can easily be overcome.

One issue that has been encountered has been how to present the menu icons to consumers who approach the display at a plurality of different heights. If the display is a drive through ordering device, consumers may pull up to the display in a low-profile sports car (such as a Corvette) or a very tall utility truck (such as a Hummer). Further, if the display is a walk-up display, consumers approaching the device may be anywhere from four feet to six feet ten inches tall.

Exemplary embodiments provide a touch screen display where the position of the graphical user interface (GUI) may be shifted so that a plurality of different access positions can be accommodated.

The exemplary embodiments herein disclosed are not intended to be exhaustive or to unnecessarily limit the scope of the embodiments. The exemplary embodiments were chosen and described in order to explain the principles so that others skilled in the art may practice the embodiments. Having shown and described exemplary embodiments, those skilled in the art will realize that many variations and modifications may be made to affect the described invention. Many of those variations and modifications will provide the same result and fall within the spirit of the exemplary embodiments. It is the intention, therefore, to limit the embodiments only as indicated by the scope of the claims.

### BRIEF DESCRIPTION OF THE DRAWINGS

A better understanding will be obtained from a reading of the following detailed description and the accompanying drawings wherein identical reference characters refer to identical parts and in which:

FIG. 1A is an illustration showing the access position from a low profile vehicle;

FIG. 1B is an illustration showing the access position from a truck;

FIG. 2 is a front view showing an exemplary display orientation and a plurality of access points on the display;

FIG. 3A is a front view of one embodiment for shifting the GUI to provide access from a plurality of access points;

FIGS. 3B-3D are front views showing the active and in-active portions of the display when each access point is selected;

FIG. 4A is a front view of another embodiment for providing access to the GUI from a plurality of access points;

FIG. 4B is a front view of the active portion of the display and the positioning points;

FIG. 5A is a front view of another embodiment for shifting the GUI to provide access from a plurality of access points; and

FIGS. 5B and 5C are front views showing the active and in-active portions of the display when each access point is selected.

### DETAILED DESCRIPTION OF PREFERRED EMBODIMENTS

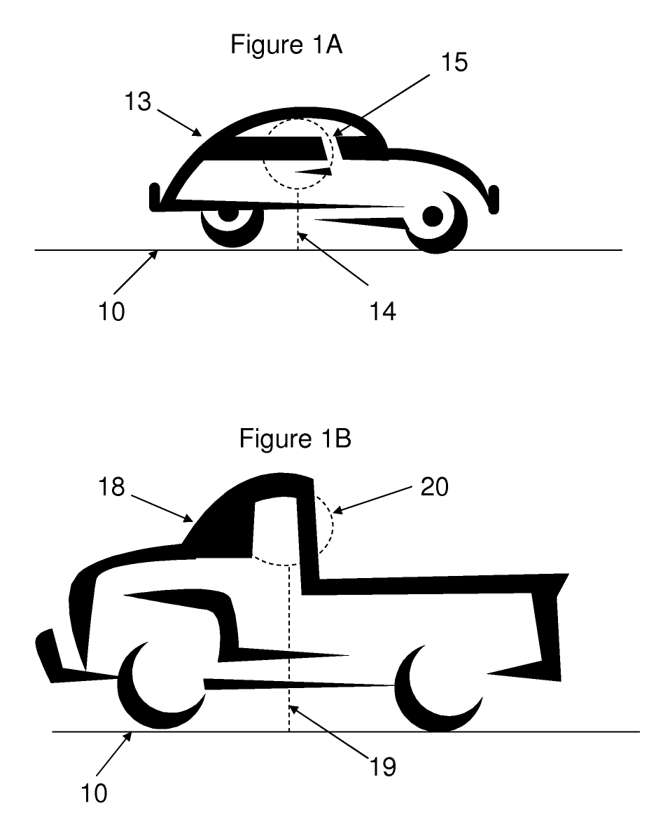

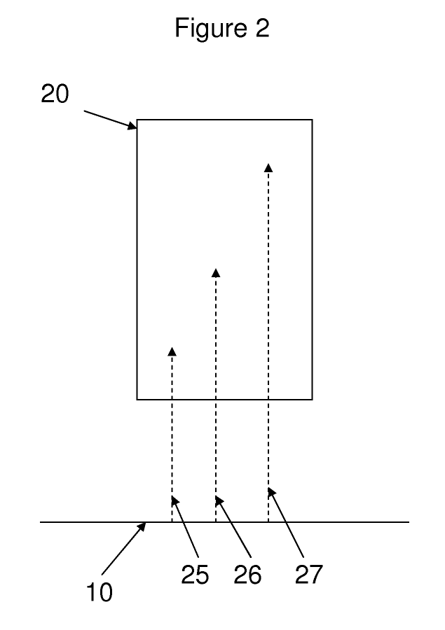

FIG. 1A shows a low profile vehicle 13 (such as a car) and its access position 15, which is located at distance 14 above ground 10. FIG. 2A shows a truck 18 and its access position 20 located at distance 19 above ground 10. In some situations, distance 19 is larger than distance 14. In some cases, the difference between distance 19 and distance 14 may be on the order of a foot or more.

FIG. 2 shows an embodiment where a display 20 is oriented in a ‘portrait’ manner so that a plurality of access positions may be accommodated. Here, three access positions at three different heights, 25, 26, and 27 relative to the ground 10 are shown. An exemplary embodiment may be capable of shifting the graphical user interface (GUI) to various GUI regions within the touch screen display 20. As used herein, the GUI is considered the series of menus and selection icons which may be presented to the consumer for their selection. The terms ‘active’ and ‘inactive’ will also be used to describe the GUI regions of the display. An active GUI region of the display may contain the actual GUI, with its location based on the access position selected by the user. An inactive GUI region is capable of displaying the GUI but is not the region selected by the user for their access position. By inactive, it is not necessary that the screen remains blank or static in that area. Inactive may simply represent areas of the screen where the user is not presented with menus and icons for selection. Graphics and advertisement may still be present within inactive GUI regions of the display, but the consumer may not be presented with a GUI within inactive portions of the display (mostly because it may be difficult for consumers to reach the area of the display that has been deemed ‘inactive’). Some embodiments however may be adapted to receive input from the inactive portions of the display, so that a user may re-orient the display after an initial location for the GUI has been selected, or for other functions that the consumer may benefit from (ex. change languages or call restaurant personnel).

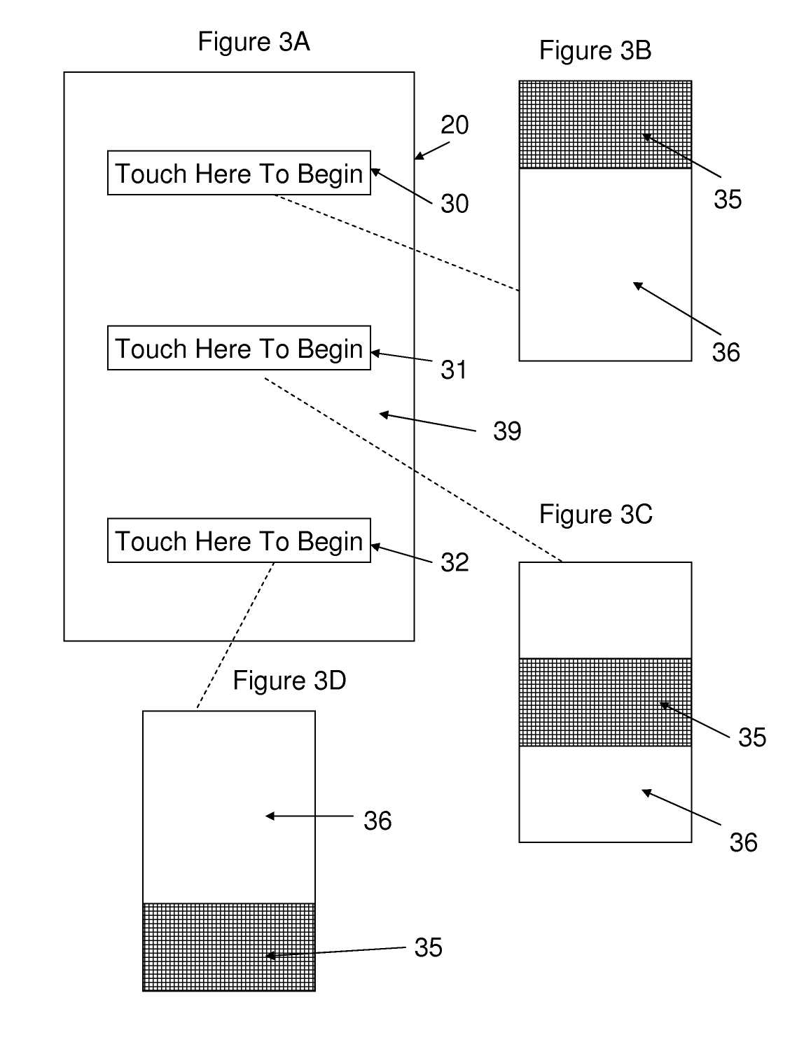

FIG. 3A shows one embodiment for the initial prompt to the user for selecting their access position. The display 20 is essentially divided into several GUI regions. Three positioning icons 30, 31, and 32 correspond to their respective GUI regions on the display. The background 39 may be inactive, but may contain advertisements including static images and full motion video. Depending on which of the positioning icons 30, 31, or 32 are selected, the GUI will be established on that particular GUI region. As shown in FIG. 3B, if icon 30 is selected by the user, then the top portion of the display becomes the active GUI region 35, and the remainder of the display becomes the inactive portion 36. As shown in FIG. 3C, if icon 31 is selected by the user, the center portion of the display becomes the active GUI region 35, and the remainder of the display becomes the inactive portion 36. Finally, as shown in FIG. 3D, if icon 32 is selected by the user, the bottom portion of the display becomes the active GUI region 35, and the remainder of the display becomes the inactive portion 36. Of course, the display can be divided into more GUI regions than three, and correspondingly more icons may be provided. Icons may not be provided with some embodiments.

The active GUI regions shown in FIGS. 3B-3D are where the GUI would be presented for the user as this region has been selected as their access point. Embodiments may create two separate coordinate systems for the system. An absolute coordinate system would cover the absolute positions of icons across the entire display and would be used to establish icons 30, 31, and 32. A relative coordinate system could cover the relative positions of icons and menus within the active GUI region only, and would be used to establish the icons and menus of the GUI. The relative coordinate system may be placed based on a first locating touch by the user.

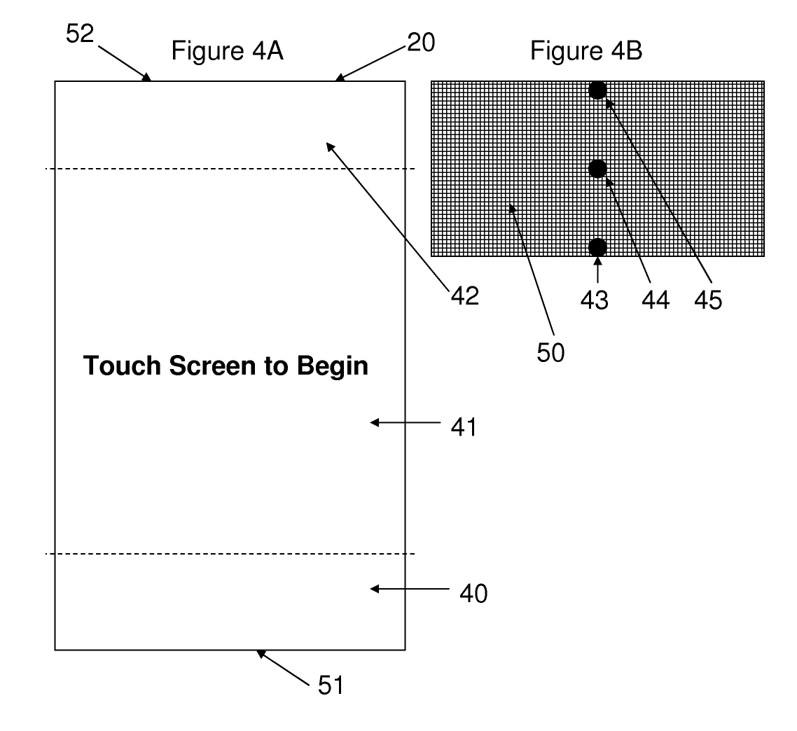

FIG. 4A shows another embodiment for the initial prompt to the user for selecting their access point. In this embodiment, no specific icons may be presented for the user's selection. The user may touch any portion of the display 20. The display may be partitioned into three sections 40, 41, and 42. The dashed lines which are shown in FIG. 4A are not visible on the display, but simply represent the partitioning lines for selecting the proper orientation of the active GUI region. FIG. 4B shows an active GUI region 50 layout and three positioning points 43, 44, and 45 which may be used with this embodiment. Thus, an algorithm can be used to position the active GUI region based on a first locating touch by the user. An example for this algorithm could be the following.

If the locating touch is within section 42, positioning point 45 may be aligned with top edge 52 in order to place the active GUI region 50 near the top of the display. If the locating touch is within section 41, positioning point 44 is aligned with the vertical location of the user's touch in order to place the active GUI region 50 in a centered position around the user's locating touch. Finally, if the locating touch is within section 40, positioning point 43 is aligned with bottom edge 51 in order to place the active GUI region 50 near the bottom of the display. This approach is advantageous at least because it allows almost any position on the display to be selected as the user's desired position for the GUI. Thus, a large number of GUI regions are available for possible activation by the user.

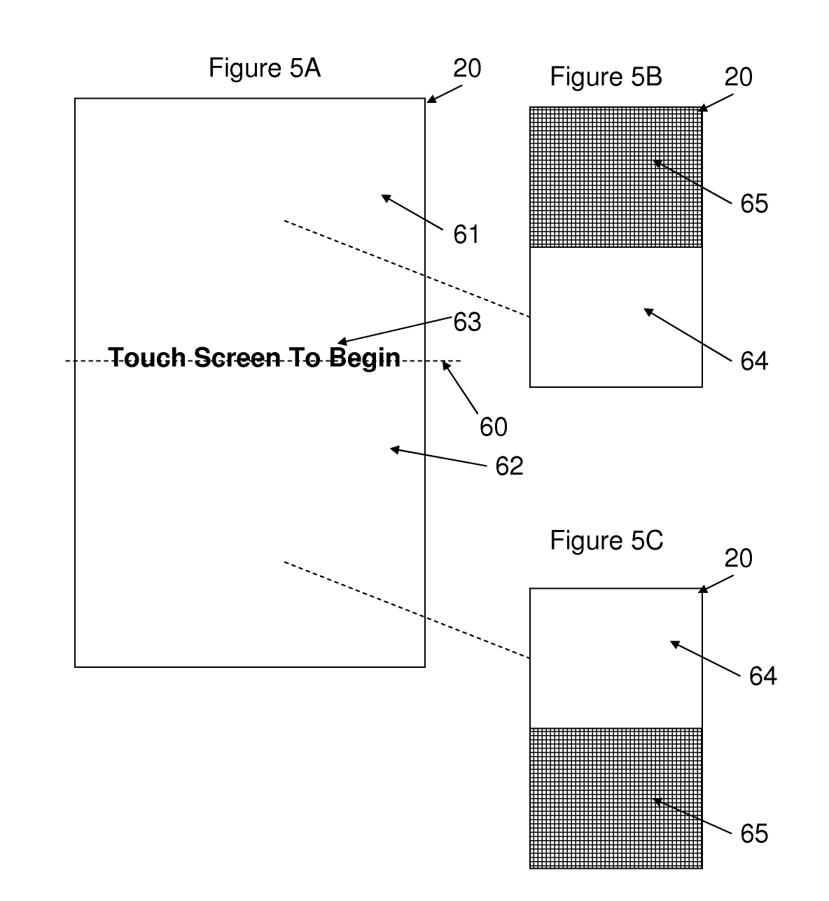

FIG. 5A shows another embodiment for the initial prompt to the user for selecting their access point. In this embodiment, partitioning line 60 divides the display 20 into upper GUI region 61 and lower GUI region 62. Partitioning line 60 may not be visible on the display 20. The text 63 which is prompting the user to touch the display 20 may be located anywhere on the display 20 and may even be a moving graphic which moves all around the display 20 into both upper GUI region 61 and lower GUI region 62. The user may touch any portion of the display 20. FIG. 5B shows the active 65 and inactive 64 GUI regions of the display 20 if the user touches upper GUI region 61. FIG. 5C shows the active 65 and inactive 64 GUI regions of the display 20 if the user touches lower GUI region 62.

It should be noted that any form of touch screen technology may utilize the exemplary embodiments. These technologies would include but are by no means limited to: 4 or 5 wire resistance, surface acoustic wave, infrared, and near field imaging. Further, embodiments may be practiced with any form of flat panel display, including but not limited to LCD, plasma, and organic LED. An exemplary embodiment would use LED-backlit LCD technology.

It should also be noted that audio systems may be adapted for use with exemplary embodiments. These systems may transmit audio messages corresponding to the menus and icons which are presented to the user. These may include traditional loudspeaker technology as well as the hypersonic sound technologies which transmit sound waves above 20 kHz. Further, card readers may be used so that consumers can both place an order as well as pay for purchased items at the touch screen display. Some embodiments may include a device which will accept cash payment and return cash change to the consumer. One or more proximity sensors may also be used to sense the presence of a consumer or their vehicle to begin an audio/visual welcome message or the prompt to select a position on the screen for the GUI. Of course, for consumers which are having difficulty with the touch screen device, a traditional microphone and speaker arrangement can be provided so that a consumer may speak with an in-store associate for questions about items or problems with the display.

Exemplary embodiments may also include electrical communication between the touch screen display and the establishment from which items are being ordered and/or purchased. This electrical communication may be wired or wireless. A second display may be provided for the employees of the establishment so that orders can be processed. This second display may or may not be a touch screen display.

Embodiments are not limited to use in drive through applications. Embodiments may be used anywhere touch screen devices are used and a plurality of access positions is desired. Another example would be where walk-up touch screens are used and it is desired to account for users of a number of different heights. Further, the teachings herein can also be used to shift the GUI horizontally as well as vertically.

Having shown and described preferred embodiments, those skilled in the art will realize that many variations and modifications may be made to affect the described embodiments and still be within the scope of the claims. Thus, many of the elements indicated above may be altered or replaced by different elements which will provide the same result and fall within the spirit of the claimed embodiments. It is the intention, therefore, to limit the invention only as indicated by the scope of the claims.

What is claimed is:

1. A touch screen device comprising:
a touch screen display having two or more GUI regions; and
a GUI located within one of the GUI regions and capable of being located within any of the GUI regions based on a locating touch.

2. The touch screen device of claim 1 further comprising:
a positioning icon within each GUI region.

3. The touch screen device of claim 1 wherein:
said touch screen display contains two GUI regions.

4. The touch screen device of claim 3 wherein:
the GUI regions do not substantially overlap one another.

5. The touch screen device of claim 1 wherein:
each GUI region is at a different location vertically.

6. The touch screen device of claim 1 wherein:
the GUI regions which do not contain the GUI are displaying advertising materials.

7. The touch screen device of claim 1 wherein:
said touch screen display is an LED-backlit LCD display.

8. A touch screen device comprising:
an LCD touch screen display;
two or more GUI regions located in different vertical positions across the display; and
a GUI located within one of the GUI regions making it an active region, and capable of being located within any of the GUI regions based on a locating touch.

9. The touch screen device of claim 8 wherein:
the GUI regions do not substantially overlap one another.

10. The touch screen device of claim 8 further comprising:
an electronic display adapted to show the items ordered from the touch screen device; and
an electrical connection between the touch screen device and the electronic display.

11. The touch screen device of claim 8 further comprising:
advertising materials within each of the inactive GUI regions.

12. The touch screen device of claim 8 further comprising:
positioning icons within the LCD touch screen display and associated with each GUI region.

13. A method for positioning a GUI comprising the steps of:
presenting a touch screen display having two or more GUI regions;
accepting a locating touch from a user;
associating the locating touch with an appropriate GUI region; and
positioning the GUI within the appropriate GUI region.

14. The method of claim 13 further comprising the steps of:
accepting a second locating touch from a user;
associating the second locating touch with a second appropriate GUI region; and
re-positioning the GUI within the second appropriate GUI region.

15. The method of claim 13 further comprising the step of:
displaying advertising information on the remaining GUI regions which do not contain the GUI.

16. The method of claim 13 further comprising the step of:
prompting the user for a locating touch using audible sounds prior to performing said accepting step.

17. The method of claim 16 further comprising the step of:
detecting the presence of a user prior to performing the prompting step.

18. The method of claim 13 further comprising the step of:
prompting the user for a locating touch using positioning icons prior to the accepting step.

19. The method of claim 13 further comprising the steps of:
accepting a plurality of selections from the user from the GUI; and
electrically transmitting the selections of the user to a second display.
